(19) United States
(12) Patent Application Publication
(10) Pub. No.: US 2012/0322649 A1
(43) Pub. Date: Dec. 20, 2012

(54) PROCESSES AND APPARATUSES FOR REGENERATING CATALYST PARTICLES

(75) Inventors: Michael A. Moore, Des Plaines, IL (US); Paul A. Sechrist, South Barrington, IL (US); Bryan K. Glover, Algonquin, IL (US)

(73) Assignee: UOP LLC, Des Plaines, IL (US)

(21) Appl. No.: 13/163,336

(22) Filed: Jun. 17, 2011

(51) Int. Cl. B01J 38/20; B01J 8/08

(52) U.S. Cl. 502/49; 422/232

(57) ABSTRACT

Processes and apparatuses for regenerating catalyst particles are provided. The processes include introducing spent catalyst particles to a burn zone in a continuous catalyst regenerator. When introduced, the catalyst particles, which contain a platinum group metal, carry coke deposits. In the process, a combustion gas at a temperature of at least 490° C. with an oxygen content of at least 0.5 mol % is fed to the burn zone. There, the coke deposits on the catalyst particles are combusted with the combustion gas. The catalyst particles are passed from the burn zone to a halogenation zone in the continuous catalyst regenerator and the catalyst particles are oxyhalogenated to redisperse the platinum group metal to form regenerated catalyst particles.

### FIELD OF THE INVENTION

The present invention generally relates to processes and apparatuses related to the conversion of hydrocarbons to useful hydrocarbon products, and more particularly relates to processes and apparatuses for regenerating spent hydrocarbon conversion catalyst so that the catalyst can be reused in a hydrocarbon conversion reaction.

### BACKGROUND OF THE INVENTION

Catalytic processes for the conversion of hydrocarbons using platinum group metals and catalyst supports are well known and extensively used. One such process is catalytic reforming of petroleum refinery components and another is olefin production. Eventually the catalysts used in these processes become deactivated for, among other reasons, the accumulation of coke deposits thereon. When the accumulation of coke deposits causes the deactivation, regenerating or reconditioning the catalyst to remove the coke deposits restores the activity of the catalyst. In a regeneration process, the coke-containing catalyst is contacted at high temperature with an oxygen-containing gas to combust and remove the coke. Regeneration processes can be carried out in-situ or the catalyst may be removed from a vessel in which the hydrocarbon conversion takes place and transported to a separate burn zone for coke removal. Arrangements for continuously or semi-continuously removing catalyst particles from a reaction process and for coke removal in a regeneration process are well known.

Coke combustion in a burn zone of a regeneration process is controlled by recycling a gas with low oxygen content into contact with the coke-bearing catalyst particles. In typical catalyst regeneration systems, the metal-containing catalyst particles pass downwardly from the burn zone to a subadjacent halogenation zone. Chlorine or other halogen-containing gas circulates through the halogenation zone. During steady-state operation, the halogenation zone environment also includes oxygen, enabling oxyhalogenation to redisperse the platinum group metal on the catalyst particles.

While the environment in the halogenation zone during steady state operation is required to include a significant amount of oxygen for oxyhalogenation, coked catalyst particles cannot be exposed to high levels of oxygen. Specifically, in an environment of high temperature and high oxygen content, coke burns uncontrollably. As a result of uncontrolled burning, local temperature can exceed 800° C. At this high temperature, the catalyst particles will undergo a permanent phase change, such as from gamma alumina to alpha alumina, which can cause a loss in catalytic activity. Further, the uncontrolled coke burn can release enough heat to melt the stainless steel regenerator.

Due to the potentially catastrophic result of coke entering the halogenation zone in the presence of a high oxygen content, regeneration systems are first operated in a start-up mode. In the start-up mode, no oxygen is fed to the halogenation zone. As a result, catalyst particles can enter the halogenation zone even if they still contain coke. During each pass of catalyst particles recycling through the regeneration reactor, combustion in the burn zone of coke remaining on the particles is desired. However, current practices often fail to sufficiently remove coke deposits on all catalyst particles. Specifically, subsurface coke, at the cores of the particles, often becomes refractory during the multiple passes through the regeneration reactor and extremely difficult to combust.

Further, while the start-up mode is able to prevent uncontrolled coke burn, it fails to regenerate the catalyst particles. As stated above, oxygen is required for the oxyhalogenation reaction which redisperses the platinum group metal on the catalyst particles. Therefore, it is desirable to complete the start-up mode by eliminating substantially all of the coke deposited on the catalyst particles as quickly as possible. Further, it is desirable to continue the steady state operation of such processes with complete combustion of coke deposits during a single pass through the burn zone.

Accordingly, it is desirable to provide processes and apparatuses for efficiently regenerating catalyst particles. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Processes for regenerating catalyst particles are provided. In accordance with one embodiment, a process includes introducing spent catalyst particles to a burn zone. When introduced, the spent catalyst particles contain a platinum group metal and carry coke deposits. In the exemplary embodiment, a combustion gas at a temperature of at least 490° C. and having an oxygen content of at least 0.5 mol % is fed to the burn zone. In the burn zone, the coke deposits on the catalyst particles are combusted with the combustion gas. The catalyst particles are then passed from the burn zone to a halogenation zone where the catalyst particles are oxyhalogenated to redisperse the platinum group metal on the catalyst particles to form regenerated catalyst particles.

In certain embodiments, the burn zone includes an initial burn zone maintained at about 473° C. and a secondary burn zone that receives the combustion gas at 490° C. Further, the spent catalyst particles are introduced to the initial burn zone where an initial portion of the coke deposits are combusted. After partial combustion of the coke deposits, the catalyst particles are passed to the secondary burn zone. There, a second portion of the coke deposits, e.g., substantially all of the remaining coke deposits, is combusted.

In another embodiment, a process provides for regenerating spent catalyst particles in a continuous catalyst regenerator having a burn zone and a halogenation zone. In the process, the spent catalyst particles, which contain a platinum group metal and carry coke deposits, are introduced to the burn zone. The burn zone is fed with a first oxygen-containing gas at a temperature of at least 490° C. The catalyst particles are contacted with the first oxygen-containing gas and the coke deposits on the catalyst particles are combusted. In the exemplary embodiment, the catalyst particles are passed from the burn zone to the halogenation zone. A halogen-containing gas and a second oxygen-containing gas are fed to the halogenation zone. There, the catalyst particles are contacted with the halogen-containing gas and the second oxygen-containing gas, and the catalyst particles are oxyhalogenated to redisperse the platinum group metal to form the regenerated catalyst particles.

In accordance with a further embodiment, a continuous catalyst regenerator apparatus is provided for regenerating catalyst particles containing a platinum group metal and carrying coke deposits. In the apparatus, a burn zone and a halogenation zone are provided. Further, the apparatus includes a burn zone inlet configured for feeding a first oxygen-containing gas at a temperature of at least 490° C. to the burn zone. Also, a burn zone chamber is configured for contacting the catalyst particles with the first oxygen-containing gas and combusting the coke deposits on the catalyst particles. In addition, the apparatus includes a passage configured for passing the catalyst particles from the burn zone to the halogenation zone. Structurally, the apparatus includes a halogenation zone inlet configured for feeding a halogen-containing gas and a second oxygen-containing gas to the halogenation zone. Also, the apparatus is provided with a halogenation chamber configured for contacting the catalyst particles with the halogen-containing gas and the second oxygen-containing gas and for oxyhalogenating the catalyst particles to redisperse the platinum group metal to form regenerated catalyst particles.

### BRIEF DESCRIPTION OF THE DRAWINGS

The present invention will hereinafter be described in conjunction with the following drawing figures, wherein like numerals denote like elements, and wherein:

FIG. 1 is a schematic depiction of an apparatus for regenerating catalyst particles in accordance with an exemplary embodiment; and

FIGS. 2-6 are schematic depictions of various flow paths and elements for heating the combustion gas fed to an apparatus for regenerating catalyst particles in accordance with other exemplary embodiments.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

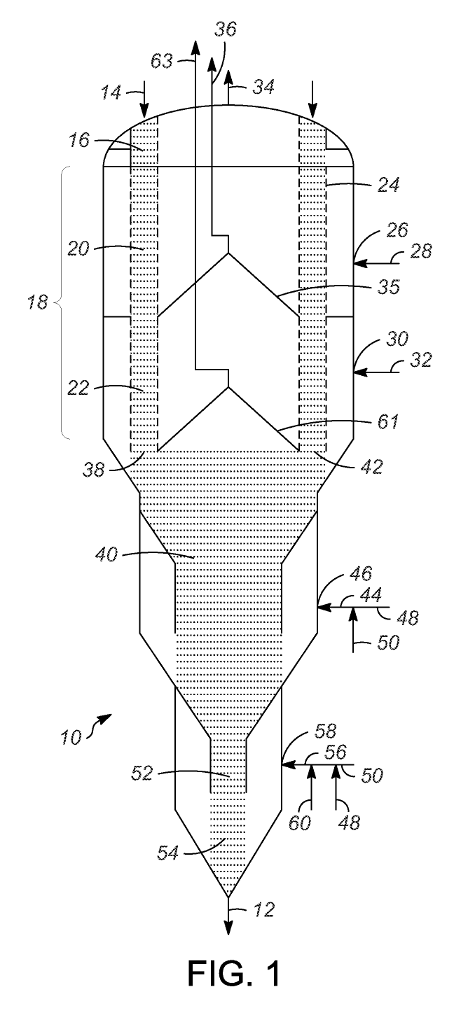

Processes for regenerating spent or coked catalyst particles are provided herein. In accordance with an exemplary embodiment, FIG. 1 is a schematic depiction of an apparatus 10, more specifically a continuous catalyst regenerator, for forming regenerated catalyst particles 12 from spent catalyst particles 14. Such an apparatus 10 is described more thoroughly in U.S. Pat. No. 7,585,803, assigned to UOP LLC and incorporated herein by reference.

In the exemplary embodiment shown in FIG. 1, a stream containing spent catalyst particles 14 carrying coke deposits 16 is provided. One source for such spent catalyst particles 14, for example, is a catalytic reforming system for converting low octane feed stocks into high octane gasoline or petrochemical precursors. As a result of such reforming process and in other catalytic processes, spent catalyst particles 14 are coated with coke. In order to retain or revive the catalytic activity of the spent catalytic particles 14, the spent catalyst particles 14 must be regenerated, i.e., substantially all of the coke must be removed from the spent catalyst particles 14. As used herein, removing “substantially all” of the coke deposits means that the regenerated catalyst particles 12 contain less than 0.1 weight percent (wt %) coke after coke removal.

While the spent catalyst particles 14 fed to the apparatus 10 for regeneration by the process embodiments may have different compositions depending upon the stream source, the spent catalyst particles 14 will be porous and will contain a platinum group metal that has catalytic activity. Typically, the spent catalyst particles 14 will include over 3 wt. % coke, though spent catalyst particles 14 having any coke content may be processed in the apparatus 10. As used herein, “carrying coke deposits” means having any coke deposits, whether the coke deposits completely or partially cover the outer surface of the spent catalyst particles 14 and/or completely or partially impregnate the pores of the spent catalyst particles 14.

The removal of the coke from the spent catalyst particles 14 is effected through combustion in a burn zone 18 of the apparatus 10. As shown, the burn zone 18 includes an initial burn zone 20 and a secondary burn zone 22. Further, the apparatus 10 defines a cylindrical chamber 24 extending between the zones 20 and 22 for receiving the spent catalyst particles 14. As illustrated, the stream of spent catalyst particles 14 is first introduced to the initial burn zone 20. The initial burn zone 20 is maintained at relatively lower temperatures, such as at 473° C. In the initial burn zone 20, coke that is easiest to combust, e.g., the outermost and non-refractory coke, is combusted on the spent catalyst particles 14. Then, the spent catalyst particles 14 are passed to the secondary burn zone 22. The secondary burn zone 22 is maintained at a higher temperature, such as at 490° C. or higher. As a result, the more difficult to burn coke is combusted in the secondary burn zone 22. This design prevents too much combustion at once and extremely high temperatures at the spent catalyst particles 14, which would otherwise result from combustion of all of the coke at once or immediately upon entry to the burn zone 18.

As shown, the apparatus 10 further defines at least one inlet 26 for feeding a combustion gas 28 containing oxygen to the initial burn zone 20. Also, the apparatus 10 further defines at least one inlet 30 for feeding a combustion gas 32 containing oxygen to the secondary burn zone 22. To control combustion of coke in the burn zone 18, the oxygen content of the combustion gases 28, 32 and of the environment in the burn zones 20 and 22 is tightly controlled. Specifically, during a start-up mode, the oxygen content of the combustion gas 32 is at least 0.5 mol %. In certain embodiments, the oxygen content of the combustion gas 32 is about 0.5-1.0 mol %. In other embodiments, the oxygen content of the combustion gas 32 is 2.4-4.0 mol %, and more preferably about 4.0 mol %. Further, the temperature of the combustion gas 32 is controlled to promote thorough combustion of the coke in the burn zone 18. For the purposes of the present embodiment, the combustion gas 32 (and the secondary burn zone 22) has a temperature of at least about 490° C. In an exemplary embodiment, the combustion gas 32 (and the secondary burn zone 22) has a temperature between about 490° C. and 593° C., more preferably between about 520° C. and 593° C., and more preferably at about 538° C. or between about 538° C. and 593° C.

When the coked or spent catalyst particles 14 enter the initial burn zone 20, the relatively lower temperature and limited but sufficient oxygen content results in the controlled combustion of the coke on the spent catalyst particles 14. As a result, a combustion exhaust gas 34 is formed and is removed from the apparatus 10. It is noted that no substantial amount of gas passes between the zones 20 and 22 as they are separated by baffle 35.

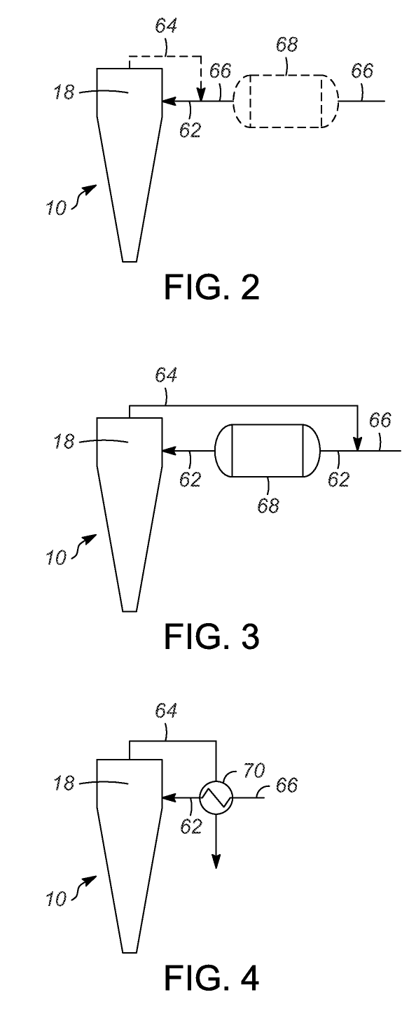

Further, when the coked or spent catalyst particles 14 enter the secondary burn zone 22, the higher temperature and limited but sufficient oxygen content results in further controlled combustion of the remaining, typically refractory, coke on the spent catalyst particles 14. As a result, a combustion exhaust gas 36 is formed and is removed from the apparatus 10. In an exemplary embodiment, the temperature in the secondary burn zone 22 is 593° C., and the temperature of the exhaust gas 36 exiting the apparatus 10 is at or above the inlet temperature, due to the exothermic nature of coke combustion. As discussed in relation to FIGS. 2-6 below, the exhaust gases 34 and/or 36 or a portion thereof may be used to form or heat the combustion gases 28 and/or 32.

As the spent catalyst particles 14 undergo combustion of coke and exit the burn zone 18, they can be considered to be decarbonized catalyst particles 38. The decarbonized catalyst particles 38 move downward through the apparatus 10 from the burn zone 18 to a halogenation zone 40 through a passage 42. The environment of the halogenation zone 40 is controlled differently between the start up and steady state modes of operation of the apparatus 10. For either mode, a halogenation gas 44 is fed into the halogenation zone 40 through at least one inlet 46. In steady state mode, the halogenation gas 44 includes a halogen-containing gas 48, such as chlorine, and an oxygen-containing gas 50, such as air. In an exemplary embodiment, the oxygen-containing gas 50 has an oxygen content of about 20.9 mol %. While FIG. 1 shows an exemplary embodiment in which a single inlet 46 feeds a combined stream of a halogen-containing gas 48 and an oxygen-containing gas 50 to the halogenation zone 40, separate inlets 46 may be provided for separate delivery of gases 48 and 50.

During steady state operation, the presence of the halogen-containing gas 48 and the oxygen-containing gas 50 in the halogenation zone 40 provides for oxyhalogenation of the decarbonized catalyst particles 38. Oxyhalogenation is necessary because the platinum group metal in the decarbonized catalyst particles 38 experiences agglomeration at the high temperatures encountered, during processing. The oxyhalogenation reaction redisperses the agglomerated platinum group metal on the decarbonized catalyst particles 38 for better catalytic activity. In an exemplary embodiment, the halogen-containing gas 48 is chlorine, and an oxychlorination reaction redisperses the platinum group metal.

Because the environment in the halogenation zone 40 during steady state mode includes a relatively high oxygen content, the decarbonized catalyst particles 38 entering the halogenation zone 40 must be void or nearly void of any coke. In an exemplary embodiment, the decarbonized catalyst particles 38 entering the halogenation zone 40 contain less than about 0.1 wt % coke; more preferably, less than about 0.05 wt % coke; more preferably, less than about 0.01 wt % coke; and more preferably about 0.0 wt % coke.

On the other hand, in start up mode, the halogenation gas 44 includes only a halogen-containing gas 48. As a result, the environment in the halogenation zone 40 during start up mode is void (about 0 mol % oxygen) or nearly void of oxygen (less than about 0.1 mol % oxygen). Because there is no or very little oxygen to support combustion in the halogenation zone 40 during start up mode, decarbonized catalyst particles 38 entering the halogenation zone 40 during start up mode can carry coke without causing uncontrolled combustion. As a result, catalyst particles 12, 14, 38 may be recycled through the apparatus 10 multiple times in order to eventually combust substantially all coke in the burn zone 18. In an exemplary embodiment, the catalyst particles 12, 14, 28 are recycled through the apparatus 10 during start up mode three times to combust substantially all of the coke in the burn zone 18.

For steady state mode, after oxyhalogenation the decarbonized catalyst particles 38 may be considered oxyhalogenated catalyst particles 52. The oxyhalogenated catalyst particles 52 pass from the halogenation zone 40 to a drying zone 54 in the apparatus 10. In steady state mode, a heated drying gas 56 is fed into the drying zone 54 through at least one inlet 58. The drying gas 56 may include an inert gas 60, a halogen-containing gas 48, and/or an oxygen-containing gas 50, such as air. In an exemplary embodiment, the drying gas 56 is air having a temperature of about 565° C. Further, in an exemplary embodiment, the oxygen-containing gas 50 has an oxygen content of about 20.9 mol %. In the drying zone 54, the drying gas 56 is blown across the oxyhalogenated catalyst particles 52 to remove water that results from the upstream reactions.

During start up mode, the drying gas 56 may include an inert gas 60, such as nitrogen and/or a halogen-containing gas 48, but does not include any oxygen-containing gas 50. As a result, decarbonized catalyst particles 38 (note that during start-up oxyhalogenation is not taking place) that retain some coke deposits may enter the drying zone 54 without causing uncontrolled combustion. In the drying zone 54, the drying gas 56 is blown across the decarbonized catalyst particles 38 during start up to remove water that results from the upstream reactions.

While FIG. 1 shows an exemplary embodiment in which a single inlet 58 feeds a combined stream of gases 48, 50 and/or 60 to the drying zone 54, separate inlets 58 may be provided for separate delivery of gases 48, 50, and 60.

Because the drying gas 56 fed through inlet 58 may include the halogen-containing gas 48 and oxygen-containing gas 50, it may not be necessary to feed those gases 48 and 50 into the halogenation zone 40 via inlet 46. Specifically, if the drying zone 54 is in fluid communication with the halogenation zone 40, the gases necessary in the halogenation zone 40 may be fed to it by the inlet 58 via the drying zone 54. For such an embodiment, inlet 46 need not be used, or may be used in addition to inlet 58. Likewise, though not preferred, if the drying zone 54, halogenation zone 40, and burn zone 18 are in fluid communication, gases fed to the apparatus in one zone may be designed to feed or partially feed other zones. It is noted however, that a baffle 61 keeps the gases of the halogenation zone 40 separate from the gases in the burn zone 18. Gases from the halogenation zone 40 may be removed from the apparatus 10 through line 63.

As shown in FIG. 1, after passing through the drying zone 54, the regenerated catalyst particles 12 exit the apparatus 10 and may be fed back to the catalytic reforming system or other catalytic system or recycled to the stream of spent catalyst particles 14 feeding into the burn zone 18.

Referring now to FIGS. 2-6, various embodiments for preparing the combustion gases 28 and/or 32 for use in the burn zone 18 of the apparatus 10 are provided. For expediency, combustion gases 28 and/or 32 are singly and collective numbered 62 in relation to FIGS. 2-6. Further, exhaust gases 34 and/or 36 are singly and collectively numbered 64 in relation to FIGS. 2-6. Also, burn zone 18 can describe either or both initial burn zone 20 and secondary burn zone 22. In any event, any one of the processes described may apply only to the combustion gas 28 and initial burn zone 20, or only to the combustion gas 32 and secondary burn zone 22.

In FIG. 2, three separate embodiments are illustrated. In the first exemplary embodiment, a source gas 66 containing oxygen is fed to and heated by a heater 68. Then, the heated source gas 66, which is now combustion gas 62, is fed to the burn zone 18 without further mixing or processing, i.e., exhaust gas 64 is not mixed with the source gas 66. For such an embodiment, the heated source gas 66 alone forms the combustion gas 62. In this arrangement, the oxygen content and temperature of the combustion gas 62 is directly controlled.

In the second embodiment shown in FIG. 2, the exhaust gas 64 is mixed with the source gas 66 after it is heated by heater 68 to form the combustion gas 62. In this manner, the heat in the exhaust gas 64 is utilized by the combustion gas 62. In an exemplary embodiment, the source gas 66 may comprise air and may be heated to about 450° C. before mixture with the exhaust gas 64 brings the combustion gas temperature to at least 490° C. In the third embodiment of FIG. 2, the heater 68 is not used. Instead, the source gas 66 is heated only by mixing with the exhaust gas 64 to form the combustion gas 62.

Referring now to FIG. 3, an exemplary embodiment is shown in which the exhaust gas 64 is mixed with the source gas 66 upstream of the heater 68. As a result, the combustion gas 62 is formed and then heated by heater 68 before being fed to the burn zone 18. In FIG. 4, an alternate embodiment is illustrated in which a heat exchanger 70 is used to heat the source gas 66 with the exhaust gas 64. As shown, the heated source gas 66 forms the combustion gas 62 alone; however, mixing with the exhaust gas 64 along with heat exchange at heat exchanger 70 is envisioned by the embodiment.

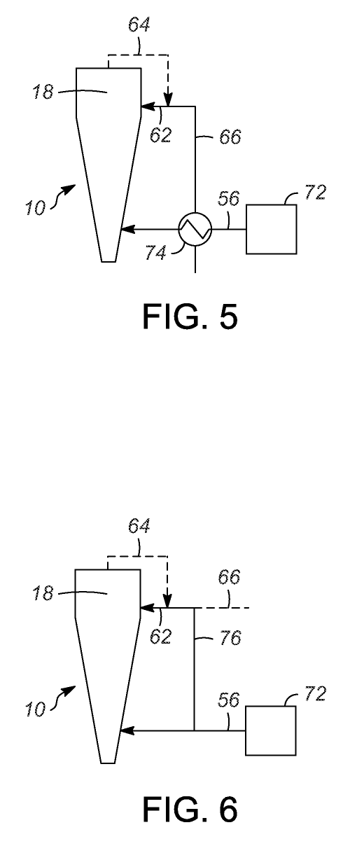

Referring now to FIG. 5, it can be seen that the apparatus 10 includes a heater 72 for heating the drying gas 56 (which may comprise only oxygen-containing gas 50). In FIG. 5, a heat exchanger 74 transfers heat from the drying gas 56 to the source gas 66. In one embodiment in FIG. 5, the heated source gas 66 forms the combustion gas 62 alone. In another embodiment in FIG. 5, the exhaust gas 64 is mixed with the heated source gas 66 to form the combustion gas 62.

As shown in FIG. 6, the combustion gas 62 may be formed from a portion 76 of the heated drying gas 56 (which may comprise only oxygen-containing gas 50). In one exemplary embodiment in FIG. 6, the portion 76 of the heated drying gas 56 forms the combustion gas 62 alone. In another exemplary embodiment, the source gas 66 is mixed with the portion 76 of the heated drying gas 56 to form the combustion gas 62. In an alternative exemplary embodiment, the exhaust gas 64 is mixed with the portion 76 of the heated drying gas 56 to form the combustion gas 62. In another exemplary embodiment, the source gas 66 and the exhaust gas 64 are mixed with the portion 76 of the heated drying gas 56 to form the combustion gas 62.

Though multiple embodiments regarding the formation of the combustion gas 62 are illustrated, the combustion gas 62 in each obtains the characteristics necessary for combusting substantially all of the coke on the spent catalyst particles 14 in the burn zone 18. Specifically, the illustrated embodiments provide a combustion gas 62 having the desired oxygen content disclosed above and the temperature disclosed above for proper catalyst regeneration. Further, it is noted that flow rates of the source gas 66, exhaust gas 64, drying gas 56, and the portion 76 of the drying gas 56 may be controlled to enable proper heat transfer to attain the desired temperature of the combustion gas 62.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A process for regenerating catalyst particles comprising:
introducing spent catalyst particles to a burn zone, wherein the spent catalyst particles contain a platinum group metal and carry coke deposits;
feeding a combustion gas at a temperature of at least 490° C. and an oxygen content of at least 0.5 mol % to the burn zone;
combusting the coke deposits on the spent catalyst particles with the combustion gas;
passing the catalyst particles from the burn zone to a halogenation zone; and
oxyhalogenating the catalyst particles to redisperse the platinum group metal on the catalyst particles to form regenerated catalyst particles.

2. The process of claim 1 wherein the burn zone includes an initial burn zone and a secondary burn zone, wherein the spent catalyst particles are introduced to the initial burn zone, and wherein the combustion gas is fed to the secondary burn zone, the process further comprising:
maintaining the initial burn zone at a temperature of about 473° C.;
combusting an initial portion of the coke deposits in the initial burn zone;
passing the spent catalysts particles to the secondary burn zone wherein a secondary portion of the coke deposits are combusted.

3. The process of claim 2 wherein an initial exhaust gas is formed by combustion of the coke deposits in the initial burn zone and a secondary exhaust gas is formed by combustion of the coke deposits in the secondary burn zone, the process further comprising:
removing the initial exhaust gas from the initial burn zone;
removing the secondary exhaust gas from the secondary burn zone; and
mixing the initial exhaust gas and the secondary exhaust gas with an oxygen feed to create the combustion gas.

4. The process of claim 3 further comprising:
passing the catalyst particles from the halogenation zone to a drying zone;
heating a drying gas to about 400-565° C.;
feeding the drying gas to the drying zone and drying the catalyst particles; and
diverting a portion of the drying gas from the heater to form the oxygen feed for mixture with the exhaust gases.

5. The process of claim 1 wherein an exhaust gas is formed by combustion of the coke deposits, the process further comprising:
removing the exhaust gas from the burn zone; and
heating the combustion gas through heat exchange with the exhaust gas.

6. The process of claim 1 further comprising:
passing the catalyst particles from the halogenation zone to a drying zone;
heating a drying gas to about 400-565° C.; and
feeding the drying gas to the drying zone and drying the catalyst particles; and
diverting a portion of the drying gas to form the combustion gas.

7. A process for regenerating spent catalyst particles in a continuous catalyst regenerator having a burn zone and a halogenation zone, the process comprising:
introducing the spent catalyst particles to the burn zone, wherein the spent catalyst particles contain a platinum group metal and carry coke deposits;
feeding a first oxygen-containing gas at a temperature of at least 490° C. to the burn zone;
contacting the spent catalyst particles with the first oxygen-containing gas and combusting the coke deposits;
passing the catalyst particles from the burn zone to the halogenation zone;
feeding a halogen-containing gas and a second oxygen-containing gas to the halogenation zone; and
contacting the catalyst particles with the halogen-containing gas and the second oxygen-containing gas and oxyhalogenating the catalyst particles to redisperse the platinum group metal to form regenerated catalyst particles.

8. The process of claim 7 wherein the burn zone includes an initial burn zone and a secondary burn zone, wherein the spent catalyst particles are introduced to the initial burn zone, and wherein the combustion gas is fed to the secondary burn zone, the process further comprising:
maintaining the initial burn zone at a temperature of about 473° C.;
combusting an initial portion of the coke deposits in the initial burn zone;
passing the spent catalysts particles to the secondary burn zone wherein a secondary portion of the coke deposits are combusted.

9. The process of claim 7 wherein an exhaust gas is formed by combustion of the coke deposits, the process further comprising:
removing the exhaust gas from the burn zone; and
mixing the exhaust gas with a third oxygen-containing gas to create the first oxygen-containing gas.

10. The process of claim 9 further comprising:
before mixing the third oxygen-containing gas with the exhaust gas, heating the third oxygen-containing gas.

11. The process of claim 10 wherein the continuous catalyst regenerator includes a drying zone, the process comprising:
passing the catalyst particles from the halogenation zone to the drying zone;
heating a fourth oxygen-containing gas to about 400-565° C. with a heater;
feeding the fourth oxygen-containing gas to the drying zone;
contacting the catalyst particles with the fourth oxygen-containing gas and drying the catalyst particles; and
heating the third oxygen-containing gas through heat exchange with the fourth oxygen-containing gas.

12. The process of claim 9 wherein the continuous catalyst regenerator includes a drying zone, the process comprising:
passing the catalyst particles from the halogenation zone to the drying zone;
heating a fourth oxygen-containing gas to about 400-565° C. with a heater;
feeding the fourth oxygen-containing gas to the drying zone;
contacting the catalyst particles with the fourth oxygen-containing gas and drying the catalyst particles; and
diverting a portion of the fourth oxygen-containing gas from the heater to form the third oxygen-containing gas for mixture with the exhaust.

13. The process of claim 9 further comprising:
after mixing the third oxygen-containing gas with the exhaust gas, heating the first oxygen-containing gas.

14. The process of claim 7 wherein an exhaust gas is formed by combustion of the coke deposits, the process further comprising:
removing the exhaust gas from the burn zone; and
heating the first oxygen-containing gas through heat exchange with the exhaust gas.

15. The process of claim 7 wherein the continuous catalyst regenerator includes a drying zone, the process comprising:
passing the catalyst particles from the halogenation zone to the drying zone;
heating a fourth oxygen-containing gas to about 400-565° C. with a heater;
feeding the fourth oxygen-containing gas to the drying zone;
contacting the catalyst particles with the fourth oxygen-containing gas and drying the catalyst particles; and
heating the first oxygen-containing gas through heat exchange with the fourth oxygen-containing gas.

16. The process of claim 7 wherein the oxygen-containing gas fed to the burn zone has a temperature of about 538° C.

17. The process of claim 7 wherein the first oxygen-containing gas has an oxygen content of about 0.5-1.0 mol %.

18. The process of claim 7 wherein the first oxygen-containing gas has an oxygen content of about 2.4-4.0 mol %.

19. The process of claim 7 wherein the second oxygen-containing gas has an oxygen content of about 20.9 mol %.

20. A continuous catalyst regenerator for regenerating catalyst particles, wherein the catalyst particles contain a platinum group metal and carry coke deposits, the continuous catalyst regenerator having a burn zone and a halogenation zone and comprising:
a burn zone inlet configured for feeding a first oxygen-containing gas at a temperature of at least 490° C. to the burn zone;
a burn zone chamber configured for contacting the catalyst particles with the first oxygen-containing gas and combusting the coke deposits on the catalyst particles;
a passage configured for passing the catalyst particles from the burn zone to the halogenation zone;
a halogenation zone inlet configured for feeding a halogen-containing gas and a second oxygen-containing gas to the halogenation zone; and
a halogenation chamber configured for contacting the catalyst particles with the halogen-containing gas and the second oxygen-containing gas and oxyhalogenating the catalyst particles to redisperse the platinum group metal to form regenerated catalyst particles.
